(19) United States
(12) Patent Application Publication
(10) Pub. No.: US 2013/0134348 A1
(43) Pub. Date: May 30, 2013

(54) Magnetic Materials and Systems

(71) Applicant: General Electric Company, Schenectady, NY (US)

(72) Inventors: Shyamala Halady Subraya BHAT, Bangalore (IN); Francis JOHNSON, Niskayuna, NY (US); Sudhakar Eddula REDDY, Bangalore (IN); Jayeshkumar Jayanarayan BARVE, Bangalore (IN)

(73) Assignee: GENERAL ELECTRIC COMPANY, Schenectady, NY (US)

(21) Appl. No.: 13/680,359

(22) Filed: Nov. 19, 2012

(30) Foreign Application Priority Data
Nov. 24, 2011 (IN) 4063/CHE/2011

(51) Int. Cl. H01F 1/01

(52) U.S. Cl. CPC H01F 1/015
USPC 252/62.51 R; 252/70

(57) ABSTRACT

A material is disclosed. The material includes a magnetic material. The magnetic material exhibits a metamagnetic transition to a magnetic saturation at an applied magnetic field of strength less than or equal to 1 T, in which a transition temperature of the magnetic material is within a temperature region from about 160 K to about 350K.

### BACKGROUND

The invention relates generally to a material. More particularly the invention relates to a material including a metamagnetic material.

Conventional refrigeration technologies suffer from several drawbacks. For instance, one of the more common conventional refrigeration technologies, namely, vapor compression (VC) refrigeration, is based on exploitation of the Joule-Thomson (JT) effect, where an adiabatic expansion or compression of a gas results in a temperature change of the gas. Such VC refrigeration technologies typically employ chlorofluorocarbon (CFC) based gases as working fluids, or refrigerants, which pose well documented environmental challenges, for instance, recycling of the working fluids is known to present significant environment challenges.

An alternative refrigeration technique involves a method that takes advantage of the so-called magneto-caloric effect (MCE). Such refrigeration techniques quite generally may be referred to as magnetic refrigeration techniques. The MCE is a thermal response of the magnetic materials to the application and removal of an external magnetic field. Specifically, increasing the magnitude of an externally applied magnetic field orders the magnetic moments within the material, increasing the temperature via MCE. Conversely, decreasing the magnitude of the externally applied magnetic field disorders the magnetic moments within the material, reducing temperature via MCE.

The amount of thermal response is related to the magnetic or structural entropy change with the applied external field at the Curie temperature (Tc) of the material. Generally for first order transition materials, a minimum external field is required to initiate the magnetic transition. For the currently known materials, the required field strength is reported to be above 1 Tesla (T). Lowering the required field strength leads to a smaller size magnet assembly, lowering the overall dimensions of the refrigerator and hence improving the system economics. For commercial realization of the phenomena for magnetic refrigeration, it is desirable to bring down the required field strength to less than about 1 T.

### BRIEF DESCRIPTION

Briefly, in one embodiment, a material is disclosed. The material includes a magnetic material. The magnetic material exhibits a metamagnetic transition to a magnetic saturation at an applied magnetic field of strength less than or equal to 1 T, in which a transition temperature of the magnetic material is within a temperature region from about 160 K to about 350K.

In one embodiment, a material is disclosed. The material includes a magnetic material. The magnetic material includes gadolinium, terbium, dysprosium, praseodymium, holmium, erbium, or a combination thereof in a range from about 3 atomic percent to about 12 atomic percent. The magnetic material further exhibits a metamagnetic transition to a magnetic saturation at an applied magnetic field of strength less than or equal to 1 T, in which the transition temperature of the magnetic material is within a temperature region from about 160 K to about 350K.

In one embodiment, a magneto-caloric system is disclosed. The system includes a thermal diffusivity matrix that includes a plurality of miniature structures that are magnetically coupled to a magnetic field and thermally coupled to a heat transfer fluid. The plurality of miniature structures include a material that is magnetically coupled to a magnetic field. The material includes a magnetic material. The magnetic material exhibits a metamagnetic transition to a magnetic saturation at an applied magnetic field of strength less than or equal to 1 T, in which a transition temperature of the magnetic material is within a temperature region from about 160 K to about 350K.

### DRAWINGS

These and other features, aspects, and advantages of the present invention will become better understood when the following detailed description is read with reference to the accompanying drawing, wherein:

FIG. 1 is a schematic representation of a magneto-caloric system, according to one embodiment of the invention;

FIG. 2 illustrates a thermal diffusivity matrix designed according to an aspect of the invention;

FIG. 3 represents magnetization of a base magnetic material at various temperatures at a constant applied field of about 0.01 T;

FIG. 4 represents magnetization of an example magnetic material at various temperatures at a constant applied field of about 0.01 T;

FIG. 5 represents relationship between magnetization of a base magnetic material with applied magnetic field at various temperatures around the curie temperature of the magnetic material;

FIG. 6 represents relationship between magnetization of an example magnetic material with applied magnetic field at various temperatures around the curie temperature of the magnetic material;

FIG. 7 represents relationship between magnetization of an example magnetic material with applied magnetic field at various temperatures around the curie temperature of the magnetic material; and

FIG. 8 shows the entropy of the example magnetic material extracted from the magnetization versus field curves.

### DETAILED DESCRIPTION

In the following description and the claims that follow, whenever a particular aspect or feature of an embodiment of the invention is said to comprise or consist of at least one element of a group and combinations thereof, it is understood that the aspect or feature may comprise or consist of any of the elements of the group, either individually or in combination with any of the other elements of that group. Similarly, the singular forms “a”, “an” and “the” include plural referents unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about” may not be limited to the precise value specified, and may include values that differ from the specified value. In at least some instances, the approximating language may correspond to the precision of an instrument for measuring the value. In the present discussions it is to be understood that, unless explicitly stated otherwise, any range of numbers stated during a discussion of any region within, or physical characteristic of, is inclusive of the stated end points of the range. As used herein, the term “around” used with a value includes the specified value and the adjacent values. For example, “around the Curie temperature” as used herein in the application means that the value includes the Curie temperature, and up to about 15K below and above the Curie temperature.

Those skilled in the art would be aware that MC materials may be classified as positive MC materials or as negative MC materials. Positive MC materials are those which warm up when adiabatically magnetized and cool down when demagnetized adiabatically, while negative MC materials cool down when magnetized and warm up when demagnetized. The descriptions herein are applicable to both positive and negative MC materials. However, for the sake of brevity, the discussions herein are developed with reference to “positive” MC materials.

In one embodiment of the invention, a material is described. The material includes a magnetic material. The material including the magnetic material may be a single material element or compound. In one embodiment, the material includes a magnetic material and at least one other material that may be magnetic or non-magnetic. In another embodiment, the material is the magnetic material. As used herein and rest of the application, magnetism is a property of materials that respond at an atomic or subatomic level to an applied magnetic field and magnetic materials are those materials that can be either attracted or repelled when placed in an external magnetic field and can be magnetized themselves.

In one embodiment, the magnetization (M or B) or magnetic polarization is the vector field that expresses the density of permanent or induced magnetic dipole moments in a magnetic material. The origin of the magnetic moments responsible for magnetization can be either microscopic electric currents resulting from the motion of electrons in atoms, or the spin of the electrons or the nuclei. Net magnetization of a magnetic material results from the response of a material to an external magnetic field, together with any unbalanced magnetic dipole moments

In one embodiment, the magnetic material described herein is a metamagnetic material. A metamagnetic material is a material having a magnetic-field-induced first order phase transition, from a less magnetically ordered state to a more magnetically ordered state, or vice versa at a field dependent transition temperature. As used herein, a phase transition between two magnetic phases is considered to be of first-order when the first order derivatives of the thermodynamic potential changes discontinuously and such values as entropy, volume and magnetization displays a jump at the point of transition. In one embodiment, the transition temperature is around its Curie temperature. In one embodiment, the metamagnetic material is a material having a magnetic-field-induced first order transition, from a less magnetically ordered state to a more magnetically ordered state around its Curie temperature. While the descriptions such as “less ordered state” and “more ordered state” are comparative terms, some of the non-limiting examples for a less ordered state may be a paramagnetic state, a ferrimagnetic state, or an antiferromagnetic state and a non-limiting example for a more ordered state is a ferromagnetic state. In one embodiment, a metamagnetic material is a magnetic material, wherein a transition around its Curie temperature causes a first order transition from a paramagnetic state to a ferromagnetic state.

In one embodiment, a metamagnetic material exhibits a metamagnetic transition with respect to an applied magnetic field, by placing the material in the path of magnetic flux of a permanent magnet or an electro-magnet. As used herein, the applied magnetic field for a metamagnetic transition is considered as the field at which the transition onsets.

As used herein, a metamagnetic transition is a magnetic-field-induced first order phase transition, from a less magnetically ordered state to a more magnetically ordered state, or vice versa at a field dependent transition temperature. In one embodiment, the metamagnetic transition is a magnetic field induced first order phase transition, from a less magnetically ordered state to a more magnetically ordered state, around its Curie temperature. In one embodiment, in a metamagnetic material, an abrupt increase in the magnetization happens at the metamagnetic transition temperature with a small change in an externally applied magnetic field. This increase in magnetization saturates at higher applied field strengths and finally the magnetic saturation curve reaches a full magnetically saturated state that is an asymptotically reachable level of that magnetic material at that temperature.

In one embodiment, a magnetic material exhibits a metamagnetic transition to a magnetic saturation at an applied magnetic field. As used herein and rest of the application, the “magnetic saturation” is the magnitude of a magnetization curve, wherein the magnetization is plotted against the applied magnetic field, of a magnetic material where the magnetization approaches at least about 85 percent of the asymptotically reachable level.

In one embodiment of the present invention, a magnetic material exhibits a metamagnetic transition to a magnetic saturation at an applied magnetic field of strength less than or equal to 1 T, wherein a transition temperature of the magnetic material is within a temperature region from about 160K to about 350K. In one embodiment, the transition temperature is the temperature at which the magnetic material undergoes a metamagnetic transition. In one embodiment, the transition temperature is within the temperature region from about 180K to about 325K. In one embodiment, the strength of the applied field to realize a metamagnetic transition to a magnetic saturation is less than or equal to about 0.75 T. In a particular embodiment, the metamagnetic transition to a magnetic saturation is realized at strength of the magnetic field less than or equal to about 0.7 T.

Metamagnetic materials exhibiting metamagnetic transition with respect to an applied field at a particular temperature region are known in the literature. However, the strength of the applied field required for the metamagnetic transition and the magnetic saturation at a particular temperature of about 160K to about 325K is normally higher than 1 T. It is desirable to bring down the required applied field strength to around 1 T or below to commercially realize the application of metamagnetic materials.

Metamagnetic materials and the materials including the metamagnetic materials may be used in different applications. One example application where these materials are useful is magnetic refrigeration, alternately denoted as magneto-caloric refrigeration. Magnetic refrigeration is a cooling technology based on the magneto-caloric effect (MCE). As noted previously, the MCE is a magneto-thermodynamic phenomenon in which a reversible change in temperature of a suitable material is caused by exposing the material to a changing magnetic field.

In a part of an overall cooling process, a decrease in the strength of an externally applied magnetic field allows the magnetic domains of a metamagnetic material to become disoriented from the magnetic field by the agitating action of the thermal energy (phonons) present in the material. This increases the entropy of the metamagnetic material. If the material is isolated so that no energy is allowed to migrate into the material during this time, i.e., in an adiabatic process, the temperature drops as the domains absorb the thermal energy to perform their reorientation. The randomization of the domains occurs in a similar fashion to the randomization at the Curie temperature, except that magnetic dipoles overcome a decreasing external magnetic field while energy remains constant, instead of magnetic domains being disrupted from internal ferromagnetism as energy is added.

In an isothermal magnetization cycle the magnetic contribution to the entropy change ΔSM can be given by the relation

$$Δ {S}_{m} ( T , H ) = {S}_{m} ( T , H ) - {S}_{m} ( T , 0 ) = {\int }_{0}^{H} {( \frac{\partial M}{\partial T} )}_{H} d H \qquad ( 1 )$$

Therefore, a higher value of magnetic saturation leads to a larger entropy change. The larger entropy will result in higher magneto-caloric cooling at smaller specific heat Cp as can be seen from the below equation.

$$Δ {T}_{ad} = - {\int }_{0}^{H} \frac{T}{{C}_{P , H}} {( \frac{\partial M}{\partial T} )}_{H} d H . \qquad ( 2 )$$

In one embodiment, a magnetic material having a cubic D2₃ crystal structure is used as the metamagnetic material. In one embodiment, the magnetic material includes a rare earth (RE) element, and a transition element. The transition elements are those elements having a partially filled d or f subshell in any common oxidation state. In one embodiment, transition elements used belonging to the d-block transition elements are used. In one embodiment, the magnetic material includes a rare earth element, a transition element, and a secondary element. In a further embodiment, the transition element used is a 3d transition element A 3d transition element as used herein includes scandium, tin, vanadium, chromium, manganese, iron, cobalt, nickel, copper, and zinc.

In one embodiment, the RE element includes one or more of the lanthanides. In one embodiment, the RE element includes lanthanum, gadolinium, terbium, dysprosium, praseodymium, holmium, erbium, neodymium, or a combination thereof. In one embodiment, the 3d-transition element includes vanadium, chromium, manganese, iron, cobalt, nickel, copper, zinc, or combinations thereof.

Without being bound by any theory, the inventors present that strength of the magnetic field required for a metamagnetic transition is influenced by the electronic structure of atoms in the metamagnetic materials. Moreover, thermodynamically stable materials exhibiting a certain electronic and atomic structure may be potential metamagnetic materials exhibiting metamagnetic transition at a lesser applied magnetic field strength at certain temperature ranges. Non limiting examples may include the manganese arsenic (MnAs) system and family of materials having the cubic D2₃ structure.

Substitution or doping of one or more RE element or a 3d-transition element by a dopant material that has a higher magnetic moment may increase local or average magnetic moment of a metamagnetic material. An increased local or average magnetic moment for the material may enhance the effect of a given magnitude of applied magnetic field, thereby decreasing the required applied magnetic field for attaining magnetic saturation at a temperature. In one embodiment, the RE element of a given magnetic material may be at least partially replaced with a RE dopant having a higher magnetic moment. In one embodiment, the 3d-transition element of a given magnetic material is at least partially replaced with a 3d-transition dopant that has higher magnetic moment than the original 3d-transition element of the material. In one embodiment, the metamagnetic material includes both a RE dopant and a 3d-transition element dopant.

In one embodiment, the RE dopant includes one or more lanthanides. In one embodiment, the RE dopant includes gadolinium, terbium, dysprosium, praseodymium, holmium, erbium, neodymium, or a combination thereof. In one embodiment, the 3d-transition dopant includes vanadium, chromium, manganese, iron, cobalt, nickel, copper, zinc, or combinations thereof. Substituting the 3d transition element with a transition element having higher magnetic moment may reduce the critical magnetic field Bc of the material. The critical magnetic field Bc is herein defined as the maximum point appearing in a dM/dH−T curve.

In one embodiment, the dopant present in a magnetic material is equal to or less than about 15 atomic percent. In one embodiment, the dopant in a magnetic material is present in an amount in the range from about 1 atomic percent to about 15 atomic percent. In one embodiment, the dopant is present in an amount in the range from about 3 atomic percent to about 12 atomic percent.

In one embodiment, the magnetic material having a D2₃ structure includes a secondary element. Inclusion of a secondary element may stabilize the composition in a cubic D2₃ structure. For example, in a La(Co)₁₃ material, if cobalt is replaced with iron, the D2₃ structure of this system may be stabilized by doping a secondary element in the iron site. Thus, a stable D2₃ structure including lanthanum and iron may be obtained by preparing a La(Fe_{1-y}Si_{y})₁₃ compound, where y<0.15. In one embodiment, the secondary element includes boron, silicon, germanium, arsenic, tin, tellurium, aluminum, or combinations thereof. In one embodiment, the secondary element is a metalloid element. In one embodiment including lanthanum and iron in a D2₃ structure, a metalloid element is substituted for about 0.1 percent to about 0.12 percent of the iron.

In one embodiment, the magnetic material includes an interstitial element. The inclusion of interstitial element is believed to aid in fine tuning the Curie temperature Tc of the magnetic materials. For example, addition of an interstitial element to a magnetic material may aid in shifting the Tc towards room temperature. In one embodiment, the interstitial element includes hydrogen, carbon, boron, nitrogen, or combinations thereof.

Without being bound by any particular theory, the inventors further present that the magnetic materials described herein, particularly those including the RE and 3d transition materials, require smaller applied magnetic field as the ratio of the 3d transition element to RE element increases. In one embodiment, a magnetic material includes a 3d transition element to RE ratio of at least about 2:1. In particular embodiments, the 3d transition element to RE ratio may be much higher, examples of which include, but are not limited to, about 17:2, about 12:1, and about 13:1. In one particular embodiment, a magnetic material includes a 3d-transition element to RE ratio equal to about 13:1.

The metamagnetic materials may be used as magneto-caloric (MC) materials wherein the effect of cooling during magnetization and demagnetization cycles may be applied for various heat-transferring needs. The magnetic materials and any materials including the magnetic materials may be used as a part of any magnet assembly. The magnet assembly may be any static magnet assembly, any moving magnet assembly, or any combinations of different static and moving magnet assemblies. In one embodiment, a thermal transfer device includes a material including the magnetic materials described above. In one embodiment, the thermal transfer device includes a cooling device that includes the magnetic material. A non-limiting list of thermal transfer devices includes a refrigerator, a heat-exchanger, an air conditioner, a thermal management device, and a heat sink.

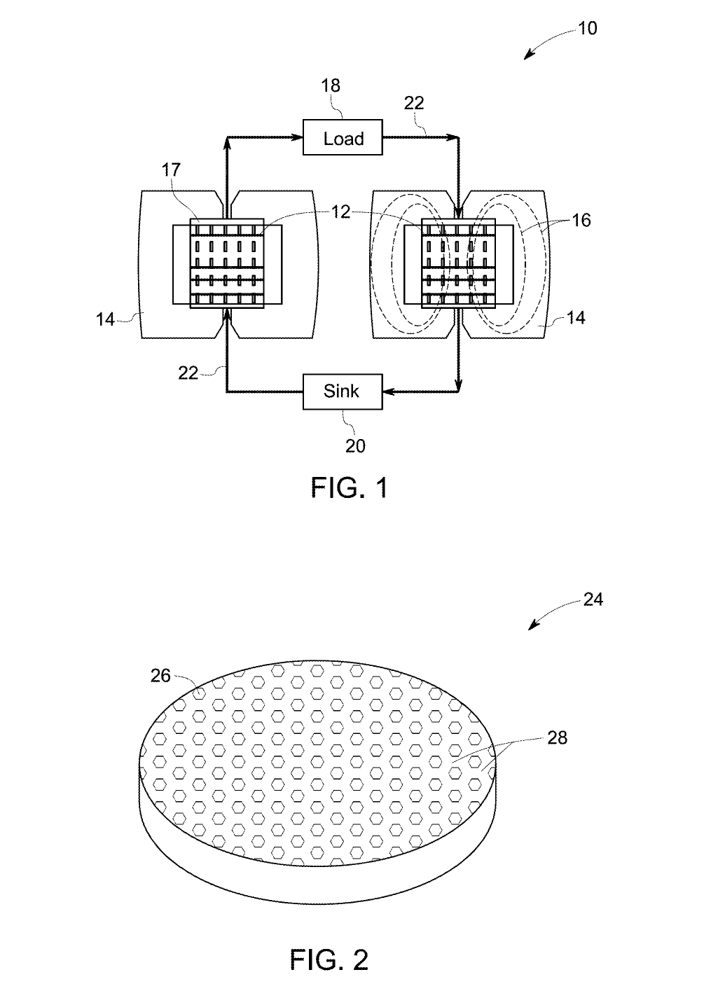

FIG. 1 illustrates an example of a magneto-caloric refrigeration system 10 that is configured to provide cooling using the metamagnetic materials. The system 10 includes a heat-exchanger 17 having multiple magneto-caloric elements 12 coupled thermally. A magnet assembly 14 is disposed around the heat-exchanger 17. The magnet assembly 14, for example, may include a permanent magnet or an electro-magnet. The magnet assembly 14 is configured to generate magnetic flux that magnetizes or demagnetizes the plurality of magneto-caloric elements 12 within the heat-exchanger cyclically. A load 18 and a sink 20 are coupled through a fluid circuit 22. A fluid path formed within the gap is coupled to the fluid circuit 22. A heat exchange fluid is configured to flow through the fluid path and fluid circuit 22.

In operation, the system 10 is configured to sequentially regulate the temperature of the plurality of magneto-caloric elements 12 within the heat-exchanger 17, for maximizing the magneto-caloric effect for each of the plurality of magneto-caloric elements 12 when subjected to a magnetic regenerative refrigeration cycle. In particular, the plurality of magneto-caloric elements may be heated or cooled through isentropic magnetization, or isentropic demagnetization (via magnetic field 16) and through transfer of heat using a fluid medium 22. The magneto-caloric elements 12 are excited by a magnetic field 16 generated by the magnet assembly 14. Such excitation results in heating or cooling of the magneto-caloric elements 12. In this embodiment, the system 10 includes a load 18 and a sink 20 thermally coupled to the magneto-caloric elements 12 in the heat-exchanger 17. The load 18 and the sink 20 include the fluid medium 22 for transferring the heat between the magneto-caloric elements 12 and the environment. The fluid medium, for example, a heat exchange fluid, is configured to exchange thermal units with the metamagnetic material. The magneto-caloric elements 12 also are designed for efficient exchange of thermal units. The heat exchange fluid 22 facilitates exchange of thermal units between the load 18 and the sink 20 that in turn heat or cool the load 18.

FIG. 2 illustrates a thermal diffusivity matrix 24 of a heat-exchanger 17 designed according to an aspect of the invention. As used herein, a thermal diffusivity matrix is a simple or complex structure consisting of the magneto-caloric materials particles or sub-structures (or shapes e.g. pins) that are intimately packed to form a gap between particles or sub-structures. A fluid path is provided within the gap to facilitate flow of heat transfer fluid and further provide thermal exchange between the heat exchange fluid and magneto-caloric material. The thermal diffusivity matrix 24 includes a plurality of miniature protrusions 26 optimized to enhance magnetic permeability. The miniature protrusions 26 are made of metamagnetic material and intimately packed to form a gap 28 between the protrusions 26. The magnetic field (16 as referenced in FIG. 1) is applied to excite the metamagnetic material of matrix 24 that in turn heats or cools the metamagnetic material. A fluid path is defined within the gap 28 to facilitate flow of a heat exchange fluid (not shown) and efficient thermal exchange between the heat exchange fluid and metamagnetic material. The miniature protrusions 26 may include at least one of a cylindrical, a pin structure, a plate structure.

### Example

The following example illustrates methods, materials and results, in accordance with specific embodiments, and as such should not be construed as imposing limitations upon the claims. The variations, inclusion or circumventing certain steps, and modifying the steps are considered to be known to a person skilled in the art.

A magnetic material La(Fe_{1-y}Si_{y})₁₃ having a D2₃ crystal structure was selected. A portion of the RE element (La) was independently replaced with Gd or Tb dopant and the magnetization against temperature and the magnetization against field were measured and the corresponding properties such as critical temperature and field at which the magnetic saturation occurs and the entropy change were extracted.

For preparing the compositions the individual, high purity, 99.99%, elements lanthanum, iron, silicon, and dopant (gadolinium or terbium) were obtained in metallic form and weighed in the desired ratio to result in a 15 gram batch. The weighed stoichiometric compositions were melted together in an arc-melting furnace, in argon atmosphere, at least five times for homogenization. The homogenized ingots were further heat treated in vacuum or inert atmosphere between 1050° C. and 1200° C. for 40-120 hours to form the D2₃ type structure.

The Curie temperatures (Tc) and the field dependence of the magnetization (MH) of the samples at various temperatures were measured using a vibrating sample magnetometer, up to a magnetic field of 5 T. Samples of about 40-50 milligrams were used for measurements.

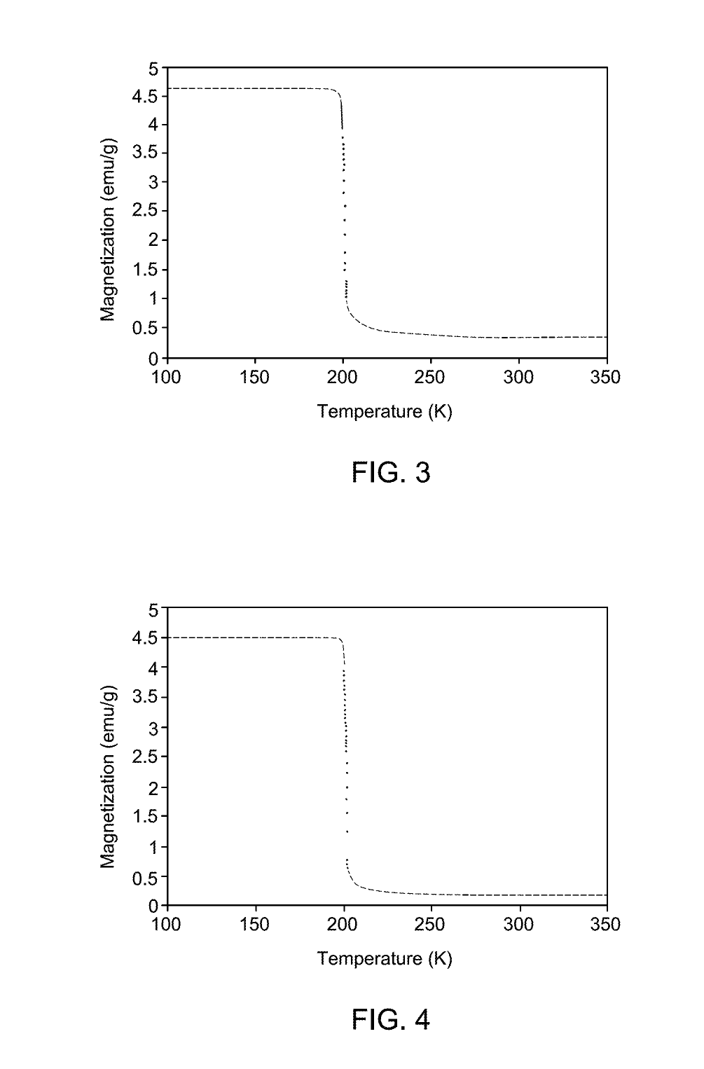

In a particular example, a dopant level of 5 atomic % of gadolinium or terbium for lanthanum, in a La(Fe_{0.89}Si_{0.11})₁₃ system were compared with the base material La(Fe_{0.89}Si_{0.11})₁₃. FIGS. 3-8 show the magnetization data and the extracted entropy of the above mentioned samples. The magnetization against temperature data, in FIG. 3 shows the Curie temperature of the base sample La(Fe_{0.89}Si_{0.11})₁₃. The magnetization against temperature data, in FIG. 4 shows the curie temperature of the 5% gadolinium doped La(Fe_{0.89}Si_{0.11})₁₃ sample.

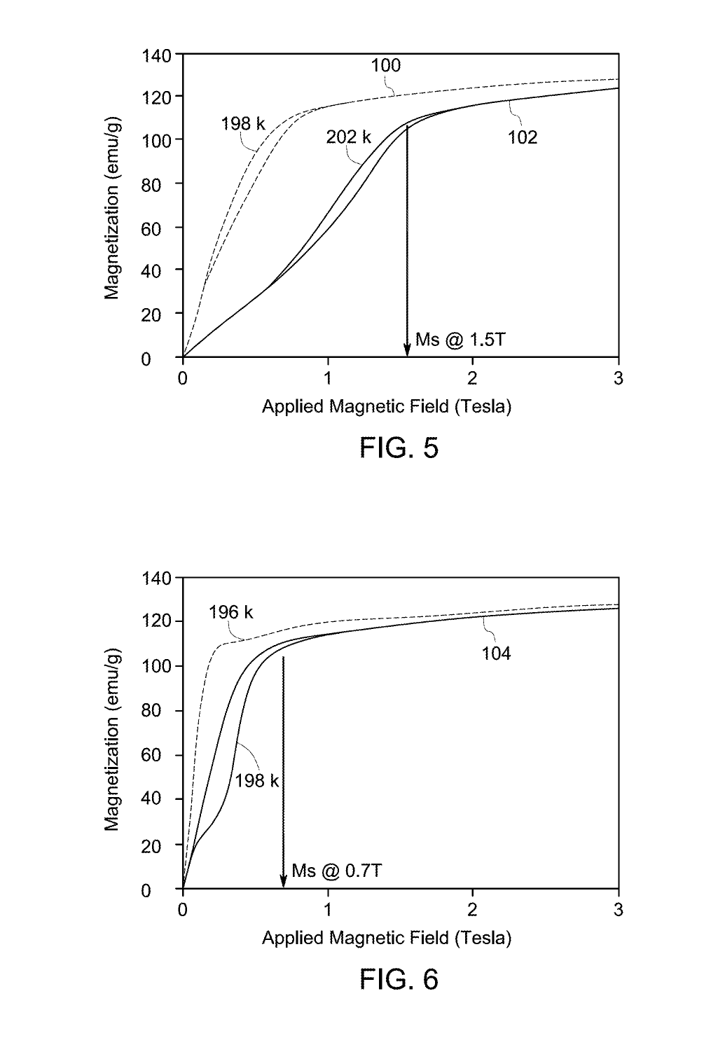

FIG. 5 depicts the magnetization values plotted against applied magnetic field for the base material La(Fe_{0.89}Si_{0.11})₁₃. Curve 100 of FIG. 5 representing the magnetization at 198K does not indicate a metamagnetic transition for the material La(Fe_{0.89}Si_{0.11})₁₃. Curve 102 representing the magnetization at 202K shows a metamagnetic transition as can be inferred from the slope change in the curve before reaching the magnetic saturation. In this curve, the magnetic saturation is observed for an applied field of strength about 1.5 T.

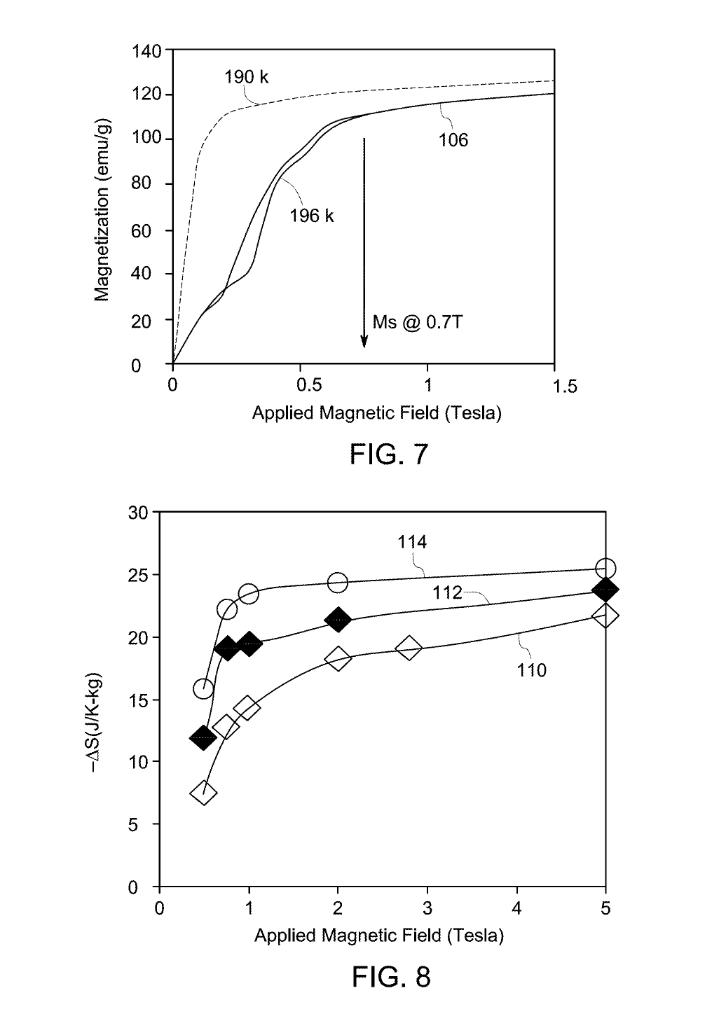

FIGS. 6 and 7 depict the magnetization values plotted against applied magnetic field at different temperatures for gadolinium doped La(Fe_{0.89}Si_{0.11})₁₃ and terbium doped La(Fe_{0.89}Si_{0.11})₁₃ respectively. These two graphs clearly show that the RE doped materials exhibited metamagnetic transition (curves 104 and 106) and saturation magnetization (magnetic saturation) at an applied field strength below 0.7 T.

FIG. 8 depicts the entropy change extracted from the MH curves, according to the equation (1). The entropy change of La(Fe_{0.89}Si_{0.11})₁₃ 110, gadolinium doped La(Fe_{0.89}Si_{0.11})₁₃ 112, and terbium doped La(Fe_{0.89}Si_{0.11})₁₃ 114 are plotted against the applied magnetic field. FIG. 8 indicates a higher entropy change for the Gd doped La(Fe_{0.89}Si_{0.11})₁₃ samples and Tb doped La(Fe_{0.89}Si_{0.11})₁₃ samples compared to the base La(Fe_{0.89}Si_{0.11})₁₃ sample at any given magnetic field, indicating the advantage of the RE doping in the D2₃ type structures.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A material comprising:
a magnetic material exhibiting a metamagnetic transition to a magnetic saturation at an applied magnetic field of strength less than or equal to 1 T, wherein a transition temperature of the magnetic material is within a temperature region from about 160 K to about 350K.

2. The material of claim 1, wherein the strength of the applied magnetic field is less than or equal to about 0.75 T.

3. The material of claim 1, wherein the temperature region is from about 180K to about 325K.

4. The material of claim 1, wherein the magnetic material belongs to cubic D2₃ crystal structure.

5. The material of claim 1, wherein the magnetic material comprises a rare earth element, a 3d transition element, a secondary element, and a dopant, wherein the magnetic moment of the dopant is more than the magnetic moment of the rare earth element.

6. The material of claim 5, wherein the magnetic material comprises lanthanum, iron, silicon, and the dopant.

7. The material of claim 6, wherein the dopant comprises a rare earth element, a 3d transition element, or a combination thereof.

8. The material of claim 7, wherein the rare earth element dopant comprises gadolinium, terbium, dysprosium, praseodymium, holmium, erbium, or a combination thereof.

9. The material of claim 7, wherein the 3d transition element dopant comprises vanadium, chromium, manganese, iron, cobalt, nickel, copper, zinc, or combinations thereof.

10. The material of claim 5, wherein the magnetic material further comprises an interstitial element.

11. The material of claim 10, wherein the interstitial element comprises hydrogen, carbon, boron, nitrogen, or combinations thereof.

12. The material of claim 5, wherein the dopant is present in an amount in the range from about 1 atomic percent to about 15 atomic percent.

13. The material of claim 12, wherein the dopant is present in an amount in the range from about 3 atomic percent to about 12 atomic percent.

14. A thermal transfer device comprising the material of claim 1.

15. The thermal transfer device of claim 14, comprising a refrigerator, an air conditioner, a thermal management device, a heat sink, or a combinations thereof.

16. A material comprising:
a magnetic material comprising gadolinium, terbium, dysprosium, praseodymium, holmium, erbium, or a combination thereof in a range from about 3 atomic percent to about 12 atomic percent, and exhibiting a metamagnetic transition to a magnetic
saturation at an applied magnetic field of strength less than or equal to 1 T, wherein the transition temperature of the magnetic material is within a temperature region from about 160 K to about 350K.

17. The material of claim 1, wherein the magnetic material belongs to cubic D2₃ crystal structure and comprises a rare earth element, a 3d transition element, and a metalloid element.

18. The material of claim 16, wherein the magnetic material is a doped La(_{Fe1-y}, Si_{y})13, wherein y≦1.5 and wherein lanthanum is doped with gadolinium, terbium, dysprosium or combinations thereof.

19. The material of claim 16, wherein the magnetic material further comprises an interstitial element.

20. The material of claim 19, wherein the interstitial element comprises hydrogen, carbon, boron, nitrogen, or combinations thereof.

21. A thermal transfer device comprising the material of claim 1.

22. A magneto-caloric system comprising:
a thermal diffusivity matrix comprising a plurality of miniature structures magnetically coupled to a magnetic field and thermally coupled to a heat transfer fluid, and comprising a material, wherein the material comprises a magnetic material exhibiting a metamagnetic transition to a magnetic saturation at an applied magnetic field of strength less than or equal to 1 T, and wherein a transition temperature of the magnetic material is within a temperature region from about 160 K to about 350K.
